(19) United States
(12) Patent Application Publication
(10) Pub. No.: US 2024/0027205 A1
(43) Pub. Date: Jan. 25, 2024

(54) TERMINAL APPARATUS AND METHOD

(71) Applicant: TOYOTA JIDOSHA KABUSHIKI KAISHA, Toyota-shi (JP)

(72) Inventors: Koji NISHIGUCHI, Izumi-shi (JP); Chiho KIMURA, Fukaya-shi (JP); Aya SUGIMOTO, Koutou-ku (JP)

(73) Assignee: TOYOTA JIDOSHA KABUSHIKI KAISHA, Toyota-shi (JP)

(21) Appl. No.: 18/355,189

(22) Filed: Jul. 19, 2023

(30) Foreign Application Priority Data
Jul. 21, 2022 (JP) 2022-116735

(51) Int. Cl. G01C 21/34; G01C 21/36

(52) U.S. Cl. CPC G01C 21/343; G01C 21/3617; G01C 21/3602; G01C 21/3647; G01C 21/362

(57) ABSTRACT

A terminal apparatus includes a memory configured to store preference information on a user, a display, and a controller. The controller is configured to identify an image selected by the user as a target image, and for each candidate spot selected based on the preference information from among a plurality of spots, control the display to display, as a representative image for the candidate spot, a spot image determined to be similar to the target image by a similar image search from among a plurality of spot images associated with the candidate spot.

### CROSS-REFERENCE TO RELATED APPLICATION

This application claims priority to Japanese Patent Application No. 2022-116735 filed on Jul. 21, 2022, the entire contents of which are incorporated herein by reference.

### TECHNICAL FIELD

The present disclosure relates to a terminal apparatus and a method.

### BACKGROUND

Technology for suggesting spots, such as facilities or sightseeing spots, to users is known. For example, Patent Literature (PTL) 1 discloses to present to a user, based on tag information on image data selected by the user and condition information on a travel plan, candidate sightseeing spots with common tag information.

### CITATION LIST

### Patent Literature

PTL 1: JP 2021-056801 A

### SUMMARY

There is room for improvement with respect to technology for suggesting spots to users. For example, in the conventional technology, it is necessary for a user to input condition information on a travel plan, so candidate sightseeing spots cannot be presented to a user who does not have a specific travel plan. In addition, the method of selecting candidate sightseeing spots based on only the match or mismatch of tag information does not always select candidate sightseeing spots with scenery similar to image data selected by a user liking scenery, for example.

It would be helpful to improve technology for suggesting spots to users.

A terminal apparatus according to an embodiment of the present disclosure includes:
a memory configured to store preference information on a user;
a display; and
a controller,
wherein the controller is configured to:
   identify an image selected by the user as a target image; and
   for each candidate spot selected based on the preference information from among a plurality of spots, control the display to display, as a representative image for the candidate spot, a spot image determined to be similar to the target image by a similar image search from among a plurality of spot images associated with the candidate spot.

A method according to an embodiment of the present disclosure is a method performed by a terminal apparatus including a memory configured to store preference information on a user, a display, and a controller, the method including:
identifying, by the controller, an image selected by the user as a target image; and
for each candidate spot selected based on the preference information from among a plurality of spots, controlling, by the controller, the display to display, as a representative image for the candidate spot, a spot image determined to be similar to the target image by a similar image search from among a plurality of spot images associated with the candidate spot.

According to an embodiment of the present disclosure, technology for suggesting spots to users is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating an example of information stored in a server; and

FIG. 3 is a sequence diagram illustrating operations of the system.

### DETAILED DESCRIPTION

Hereinafter, an embodiment of the present disclosure will be described.

### Outline of Embodiment

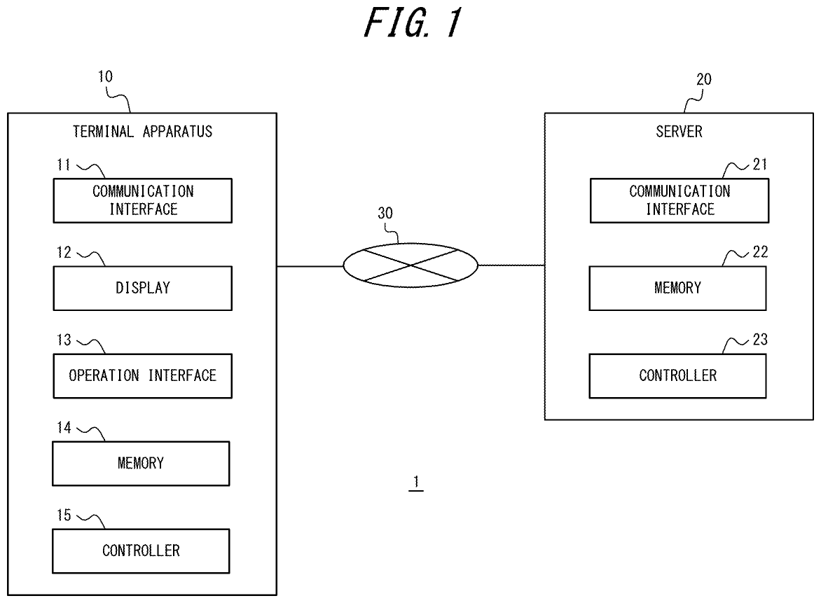

An outline of a system 1 according to an embodiment of the present disclosure will be described with reference to FIG. 1. The system 1 includes a terminal apparatus 10 and a server 20. The terminal apparatus 10 and the server 20 can communicate with each other via a network 30 including, for example, the Internet and a mobile communication network.

The terminal apparatuses 10 is a general purpose computer, such as a Personal Computer (PC), smartphone, or tablet, or a computer dedicated to the system 1. The system 1 may have any number of terminal apparatuses 10. The server 20 is configured to include one computer or a plurality of computers that can communicate with each other. As described below, in the present embodiment, the server 20 stores information on a plurality of spots (facilities, sightseeing spots, and the like). The terminal apparatus 10 can display information on spots received from the server 20.

First, an outline of the present embodiment will be described, and details thereof will be described later. The terminal apparatus 10 identifies an image selected by a user as a target image. Then, for each candidate spot selected based on the user's preference information from among the plurality of spots, the terminal apparatus 10 displays, as a representative image for the candidate spot, a spot image determined to be similar to the target image by a similar image search from among a plurality of spot images associated with the candidate spot.

Conventionally, as a method of presenting information on an object (e.g., spot or product) to a user using a computer, a method in which a predetermined representative image of the object is displayed on a screen, and when the representative image is selected by a user, the screen is switched to display detailed information on the object (e.g., a description of the object, a plurality of images, and the like) is adopted. In order to present the information on the object to the user, it is desirable to display a representative image that attracts the user's interest. According to the present embodiment, of a plurality of spot images associated with a candidate spot selected according to a user's preference, a spot image that is similar to a target image selected by the user is displayed as a representative image. Thus, for example, when the user selects an image of a landscape that the user likes, a candidate spot that matches the user's preference could be displayed with a representative image similar to that landscape. Thus, technology for suggesting spots to users is improved in that it is possible to display candidate spots with representative images that the users are likely to like visually.

Next, configurations of the system 1 will be described in detail.

### Configuration of Terminal Apparatus

As illustrated in FIG. 1, the terminal apparatus 10 includes a communication interface 11, a display 12, an operation interface 13, a memory 14, and a controller 15.

The communication interface 11 includes at least one communication interface for connecting to the network 30. The communication interface is compliant with mobile communication standards such as the 4th generation (4G) standard and the 5th generation (5G) standard, for example, but not limited to these, and may be compliant with any communication standard.

The display 12 includes one or more displays. Alternatively, the display 12 may include an interface to which an external display can be connected.

The operation interface 13 may include at least one input device for detecting user operations. The input device is a physical key, a capacitive key, a touch screen integrally provided with a display, a microphone for accepting audio input, a camera, or the like, for example, but is not limited to these. Alternatively, the operation interface 13 may include an interface to which an external input device can be connected.

The memory 14 includes one or more memories. In the present embodiment, the “memories” are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, and the like.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

### Configuration of Server

As illustrated in FIG. 1, the server 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards.

The memory 22 includes one or more memories. The memories included in the memory 22 may each function as, for example, a main memory, an auxiliary memory, or a cache memory. The memory 22 stores any information used for operations of the server 20. For example, the memory 22 may store a system program, an application program, embedded software, a database, and the like.

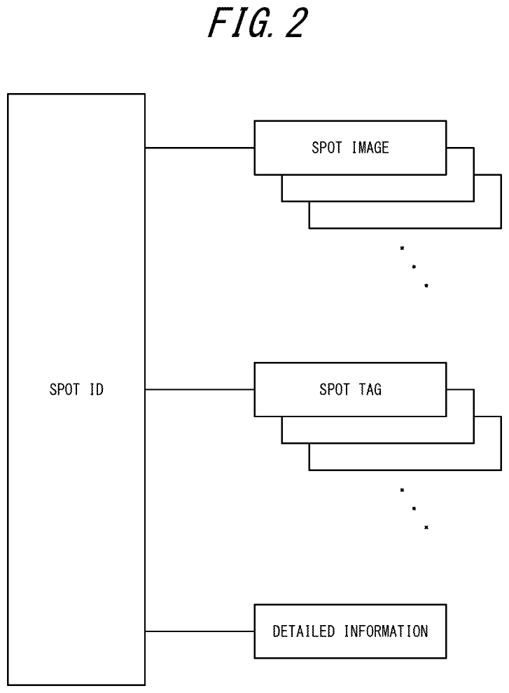

In the present embodiment, the memory 22 stores information regarding a plurality of spots. Hereafter, the spots whose information is stored in the memory 22 are also referred to as “registered spots”. Information regarding each registered spot includes, for example, as illustrated in FIG. 2, a plurality of spot images, a plurality of spot tags, and detailed information that are associated with a spot ID.

The “spot ID” is identification information uniquely identifying a spot in the system 1. The “spot images” are any images associated with the corresponding spot. In the present embodiment, each spot image is an image of a landscape of the corresponding spot. For example, a plurality of spot images of different landscapes at the corresponding spot may be associated with the single spot ID. The “spot tags” are information indicating attributes of the corresponding spot. For example, when a spot is a relatively large natural park that includes forest, river, and waterfall terrain, three spot tags, “forest”, “river”, and “waterfall” could be associated with a spot ID for the spot. The spot tags may be set in advance by an operator of the system 1, for example, or the controller 23, described below, may automatically identify and set attributes of the corresponding spot from the spot images by image recognition. In the present embodiment, all spot tags handled in the system 1 are predetermined, and there may be, for example, 100 types of predetermined spot tags. The “detailed information” is any information indicating details on the corresponding spot. For example, the detailed information may include, but is not limited to, a name, location, description, and hours of operation of the spot.

The controller 23 illustrated in FIG. 1 includes at least one processor, at least one programmable circuit, at least one dedicated circuit, or a combination of these. The controller 23 controls the operations of the entire server 20.

### Operations of System

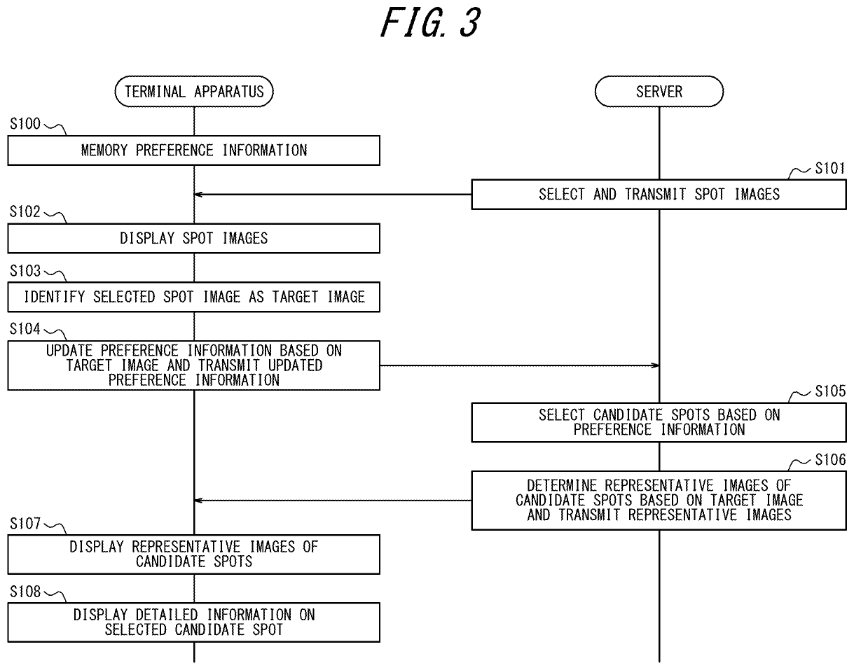

Next, operations of the system 1 will be described with reference to FIG. 3.

Step S100: The controller 15 of the terminal apparatus 10 stores a user's preference information in the memory 14.

Any method can be employed to store the user's preference information. For example, the controller 15 may control the display 12 to display information prompting the user to input information to identify or estimate preference, and store, as preference information, information indicating the user's preference identified or estimated from the input information in the memory 14. In the present embodiment, the user's preference information is described as including one or more spot tags (e.g., “forest” or “river”) that indicate the user's preference.

Step S101: The controller 23 of the server 20 selects a plurality of spot images stored in the memory 22 and transmits the spot images to the terminal apparatus 10 via the communication interface 21.

Any method may be employed to select each spot image to be transmitted to the terminal apparatus 10. For example, the controller 23 may randomly select a predetermined number of spot images from among all spot images stored in the memory 22. Here, the controller 23 may transmit, to the terminal apparatus 10, for each selected spot image, all spot tags associated with a spot ID of a spot according to the spot image, together with the spot image.

Step S102: The controller 15 of the terminal apparatus 10 controls the display 12 to display the plurality of spot images received from the server 20.

Any method can be employed to display the plurality of spot images. For example, the controller 15 may display each spot image sequentially, or may display the plurality of spot images side by side. Here, the controller 15 displays each spot image in a selectable manner by the user. For example, the controller 15 may control the display 12 to display information prompting the user to select a favorite spot image.

Step S103: The controller 15 of the terminal apparatus 10 identifies, as a target image, the spot image selected by the user from among the plurality of spot images displayed in step S102.

In the present embodiment, the user is assumed to select a spot image that the user likes.

Step S104: The controller 15 of the terminal apparatus 10 updates the preference information stored in the memory 14 based on the target image and transmits the updated preference information to the server 20 via the communication interface 11.

Any method can be employed to update the preference information based on the target image. For example, the controller 15 may add spot tags associated with a spot ID of a spot whose spot image is the target image, to the preference information as spot tags indicating the user's preference. Alternatively, the memory 14 may pre-store a machine learning model with an image as input and spot tags as output. The controller 15 may then input the target image into the machine learning model and add the output spot tags to the preference information as spot tags indicating the user's preference.

Step S105: The controller 23 of the server 20 selects one or more candidate spots from among a plurality of registered spots, based on the preference information received from the terminal apparatus 10.

Any method can be employed to select the candidate spots based on the preference information. For example, the controller 23 may vectorize spot tags associated with a spot ID for each registered spot by an index, such as Term Frequency-Inverse Document Frequency (TF-IDF), and store the vector in advance in the memory 22. In such a case, the controller 23 may vectorize the spot tags included in the preference information in the same manner and determine the similarity between the spot tags included in the preference information and the spot tags associated with the spot ID for each spot using, for example, Euclidean distance, cosine similarity, or the like. The controller 23 may then select each spot whose similarity is above a predetermined threshold as a candidate spot. Alternatively, the controller 23 may calculate, for each registered spot, the number of spot tags in common with the preference information and select each spot for which the number exceeds a predetermined threshold as a candidate spot. Thus, in step S105, candidate spots to be recommended to the user are selected by the so-called “tag matching” method.

Step S106: For each candidate spot selected in step S105, the controller 23 of the server 20 determines, as a representative image, a spot image that is determined to be similar to the target image by a similar image search from among a plurality of spot images associated with the candidate spot, and transmits the representative image to the terminal apparatus 10 via the communication interface 21.

Specifically, the controller 23 determines, as a representative image, a spot image with the highest similarity calculated by the similar image search, from among the plurality of spot images associated with the candidate spot. Thus, in step S106, a spot image with high visual similarity to the target image is determined as a representative image. For the similar image search, a method in which, for example, feature extraction is performed on each image to be compared, and feature values are vectorized to calculate similarity using an index such as Euclidean distance or cosine similarity is adopted, but any method can be used. Here, the controller 23 may transmit a spot ID of each candidate spot to the terminal apparatus 10 along with the representative image.

Step S107: The controller 15 of the terminal apparatus 10 controls the display 12 to display, for each candidate spot selected in step S105, the representative image of the candidate spot.

Any method can be employed to display the representative image of each candidate spot. For example, the controller 15 may display each representative image sequentially, or may display the representative images side by side. Here, the controller 15 displays each representative image in a selectable manner by the user.

Step S108: The controller 15 of the terminal apparatus 10 controls the display 12 to display detailed information on a candidate spot according to a representative image selected by the user.

Specifically, when a representative image is selected by the user, the controller 15 transmits, to the server 20 via the communication interface 11, a request to acquire detailed information on a candidate spot according to the representative image. In response to the request, the controller 23 of the server 20 reads detailed information on the candidate spot from the memory 22 and returns the detailed information to the terminal apparatus 10 via the communication interface 21. Here, the controller 23 may transmit spot images of the candidate spot to the terminal apparatus 10, along with the detailed information on the candidate spot. The controller 15 of the terminal apparatus 10 then controls the display 12 to display the detailed information (and the spot images) received from the server 20.

As described above, the terminal apparatus 10 according to the present embodiment identifies an image selected by a user as a target image. Then, for each candidate spot selected based on the user's preference information from among a plurality of spots, the terminal apparatus 10 displays, as a representative image for the candidate spot, a spot image determined to be similar to the target image by a similar image search from among a plurality of spot images associated with the candidate spot.

According to such a configuration, among a plurality of spot images associated with a candidate spot selected according to a user's preference, a spot image that is similar to a target image selected by the user is displayed as a representative image. Thus, for example, when a user selects an image of a landscape that the user likes, a candidate spot that matches the user's preference could be displayed with a representative image similar to that landscape. Thus, technology for suggesting spots to users is improved in that it is possible to display candidate spots with representative images that the users are likely to like visually.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which a general purpose computer functions as the terminal apparatus 10 or the server 20 according to the above embodiment can also be implemented. Specifically, a program in which processes for realizing the functions of the terminal apparatus 10 or the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

In the embodiment described above, it is described that the terminal apparatus 10 displays a plurality of spot images (step S102), and identifies, as a target image, a spot image selected by a user from among the plurality of spot images (step S103). However, an embodiment in which an image other than the spot images is identified as a target image is also possible. In one example, the memory 14 of the terminal apparatus 10 may store any number of images, for example, images captured by a camera function, images downloaded from the network 30, or the like. The controller 15 may then identify, as a target image, an image selected by a user from among the plurality of images stored in the memory 14.

1. A terminal apparatus comprising:
a memory configured to store preference information on a user;
a display; and
a controller,
wherein the controller is configured to:
identify an image selected by the user as a target image; and
for each candidate spot selected based on the preference information from among a plurality of spots, control the display to display, as a representative image for the candidate spot, a spot image determined to be similar to the target image by a similar image search from among a plurality of spot images associated with the candidate spot.

2. The terminal apparatus according to claim 1, wherein the controller is configured to identify, as the target image, an image selected by the user from among a plurality of images stored in the memory.

3. The terminal apparatus according to claim 1, wherein the controller is configured to:
control the display to display a plurality of spot images each associated with any spot; and
identify, as the target image, a spot image selected by the user from among the plurality of spot images.

4. The terminal apparatus according to claim 1, wherein the controller is configured to identify the target image and update, based on the target image, the preference information stored in the memory.

5. A method performed by a terminal apparatus comprising a memory configured to store preference information on a user, a display, and a controller, the method comprising:
identifying, by the controller, an image selected by the user as a target image; and
for each candidate spot selected based on the preference information from among a plurality of spots, controlling, by the controller, the display to display, as a representative image for the candidate spot, a spot image determined to be similar to the target image by a similar image search from among a plurality of spot images associated with the candidate spot.
